(19) United States
(12) Patent Application Publication
(10) Pub. No.: US 2015/0227330 A1
(43) Pub. Date: Aug. 13, 2015

(54) SYSTEM AND METHOD FOR THE PAIRING OF COMPONENTS OF A PRINTER-RELATED DATA REPORTING SYSTEM

(71) Applicant: Emerge Print Management, LLC, Tampa, FL (US)

(72) Inventors: Marvin D. Scaff, Tampa, FL (US); Patrick Adesso, Tampa, FL (US); Gideon Hecht, Tampa, FL (US); Jill Castellenti, Dade City, FL (US)

(21) Appl. No.: 14/621,679

(22) Filed: Feb. 13, 2015

Related U.S. Application Data
(60) Provisional application No. 61/939,374, filed on Feb. 13, 2014.
(60) Provisional application No. 61/939,388, filed on Feb. 13, 2014.
(60) Provisional application No. 61/939,365, filed on Feb. 13, 2014.
(60) Provisional application No. 61/939,403, filed on Feb. 13, 2014.
(60) Provisional application No. 61/939,419, filed on Feb. 13, 2014.

(51) Int. Cl. G06F 3/12

(52) U.S. Cl. CPC G06F 3/1236; G06F 3/1209; G06F 3/123; G06F 3/1292

(57) ABSTRACT

Provided is a system for pairing or associating hardware in a printer-related data reporting system. The system utilizes custom application-specific software installed on a mobile or wireless device to enable a technician to easily and quickly assign the components of a printer-related data reporting system via tags placed on the individual components of the reporting system and uploading the data to a central server.

### RELATED APPLICATION DATA

This application claims priority to U.S. Provisional Patent Application Ser. No. 61/939,403, filed Feb. 13, 2014, entitled “System and Method for Monitoring Printer-Related Data on USB Cables,” U.S. Provisional Patent Application Ser. No. 61/939,365, filed Feb. 13, 2014, entitled “System and Method for the Passive Monitoring and Reporting of Printer-Related Data on USB Cables,” U.S. Provisional Patent Application Ser. No. 61/939,374, filed Feb. 13, 2014, entitled “System and Method for the Near Field Communication Pairing of Components of a Printer-Related Data Reporting System,” U.S. Provisional Patent Application Ser. No. 61/939,388, filed Feb. 13, 2014, entitled “System and Method for the Barcode Pairing of Components of a Printer-Related Data Reporting System,” and U.S. Provisional Patent Application Ser. No. 61/939,419, filed Feb. 13, 2014, entitled “System and Method for the Passive Monitoring and Reporting of Network Content on USB Cables,” the contents of which are fully incorporated by reference herein for all purposes.

### TECHNICAL FIELD

This disclosure relates to a computer-implemented system and method for assigning components of a printer-related data reporting system for non-networked printers.

### BACKGROUND OF THE INVENTION

Methods for pairing hardware devices within a larger system are known in the industry. Further, near field communication (NFC) and barcode-based protocols for pairing assets are known in the industry. Existing protocols for pairing hardware devices, however, are often unnecessarily complex, time-consuming, inaccurate, and unreliable. Currently, there exists no NFC-based system or barcode-based system for pairing or associating printers and other hardware designed to monitor printer-related data.

Thus, a need exists in the industry for a simple, convenient, and cost-effective method and system for coordinating assets relating to a printer-related data reporting system. Further, a need exists in the industry for overcoming the limitations associated with the use of traditional bar code scanners and methods for coordinating assets relating to a printer-related data reporting system. The embodiments disclosed herein are aimed overcoming these and other needs in the art.

### SUMMARY OF THE INVENTION

This disclosure provides a system and method for pairing or assigning the components of a printer-related data reporting system. The system or method provides a means for a technician to assign, or pair, a USB device for monitoring printer-related data to a certain set of client-specific printers and to a specific base station in a printer-related data reporting system. Alternatively, the system disclosed herein provides a means for a technician to assign, or pair, a USB device to a certain set of client specific printers in a printer-related data reporting system that does not require a specific base station.

The disclosed system has several important advantages. For example, the present disclosure provides a system for pairing or assigning the components of a printer-related data reporting system that is more user friendly, reliable, dependable, and easier to install than existing systems.

Another advantage of the present system is that it eliminates the need for a barcode scanner for reading bar codes associated with the components of a printer-related data reporting system.

Another advantage of the present system is enabling a user to connect together the various components of a mesh network.

Still yet another possible advantage of the disclosed system is providing a system and method for identifying sources of data relating to printers and associated components.

Another advantage of the present system is the utilization of a smart phone running custom software to accomplish the NFC pairing of a printer-related data reporting system.

Another advantage of the present system is the utilization of a smart phone running custom software to accomplish the barcode paring of a printer-related data reporting system.

Yet another advantage of the present system is the use of a smart phone camera to capture information associated with a barcode to enable the pairing of components of a printer-related data reporting system.

### BRIEF DESCRIPTION OF THE DRAWINGS

For a more complete understanding of the present disclosure and its advantages, reference is now made to the following descriptions, taken in conjunction with the accompanying drawings, in which:

FIG. 1A is a flow chart depicting the NFC-based computer-implemented method and system of the present disclosure;

FIG. 1B is a flow chart depicting the barcode-based computer-implemented method and system of the present disclosure;

FIG. 1C is a flow chart of an associated printer-related data monitoring system, i.e. “USB Sniffer Process Flow Diagram”; and

FIG. 2 is a diagram depicting the components of an associated printer-related data monitoring system.

Similar reference numerals refer to similar parts throughout the several views of the drawings.

### DETAILED DESCRIPTION OF THE PREFERRED EMBODIMENT

The present invention relates to a system and method for pairing or associating the various components of a printer-related data monitoring system. One embodiment of the present invention relates to a NFC-based system and method for pairing or associating the various components of a printer-related data monitoring system. Another embodiment of the present invention relates to a barcode-based system and method for pairing or associating the various components of a printer-related data monitoring system. The monitoring system includes monitoring printer-related data on USB cables and relaying the data to a printer reporting system via a base station, wherein the monitoring is performed using USB compatible hardware affixed to a USB cable. Alternatively, the monitoring system includes monitoring printer-related data on USB cables and relaying the data to a printer reporting system, wherein the monitoring is performed using hardware affixed to a USB cable, the hardware connecting directly over the internet to the printer reporting system, thereby eliminating the need for a base station. The various components of the present invention, and the manner in which they interrelate, are described in greater detail hereinafter.

The system and method described hereinafter refers to a monitoring system that includes a base station and a USB device. However, a monitoring system that does not rely on an associated base station is envisioned to be within the scope of the present invention. To accomplish the goal of zero-configuration installation, one embodiment includes NFC Tags placed on a base station and a USB device, respectively. In another embodiment of the invention, the NFC Tag on the base station is initially scanned using an NFC-compatible smartphone running custom software, thereby registering the MAC Address of the base station on a server. Once the base station is registered, the NFC Tag on the USB device that is to be associated with the base station is scanned and the requisite information is entered for the USB device to be associated with the printer it will be monitoring.

In another embodiment, barcodes are placed on a base station and a USB device, respectively. The barcode on the base station is initially scanned using a camera on a smartphone or other suitable device running custom software, thereby registering the MAC Address of the base station on a server. Once the base station is registered, the barcode on the USB device that is to be associated with the base station is scanned and the requisite information is entered for the USB device to be associated with the printer it will be monitoring. The pairing of multiple USB devices, printers, and computers with a single base station is envisioned to be within the scope of the present invention.

The pairing of multiple USB devices, printers, and computers with a single base station is envisioned to be within the scope of the present invention. The use of multiple base stations, or no base station at all, is also envisioned. Once a USB device is registered with a base station, they are allowed to communicate on a RF mesh network and associate the USB device with the printer to be monitored. Data relating to the system configuration is then uploaded to a server, thereby enabling a printer to be monitored passively with a USB device.

The computer-implemented method and system may include, but are not limited to, the following steps. It will be appreciated by one skilled in the art that the order of steps presented herein may be performed in a different order. It will also be appreciated by one skilled in the art that the method and system described herein for pairing of hardware for monitoring and reporting printer-related data may include all, some, or none of the steps described herein.

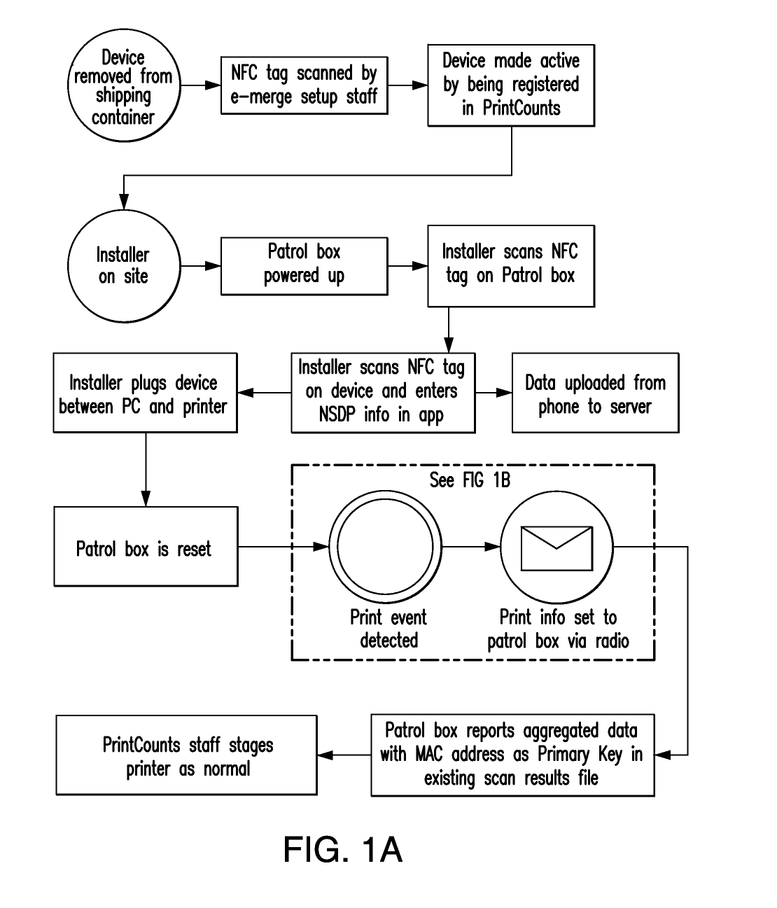

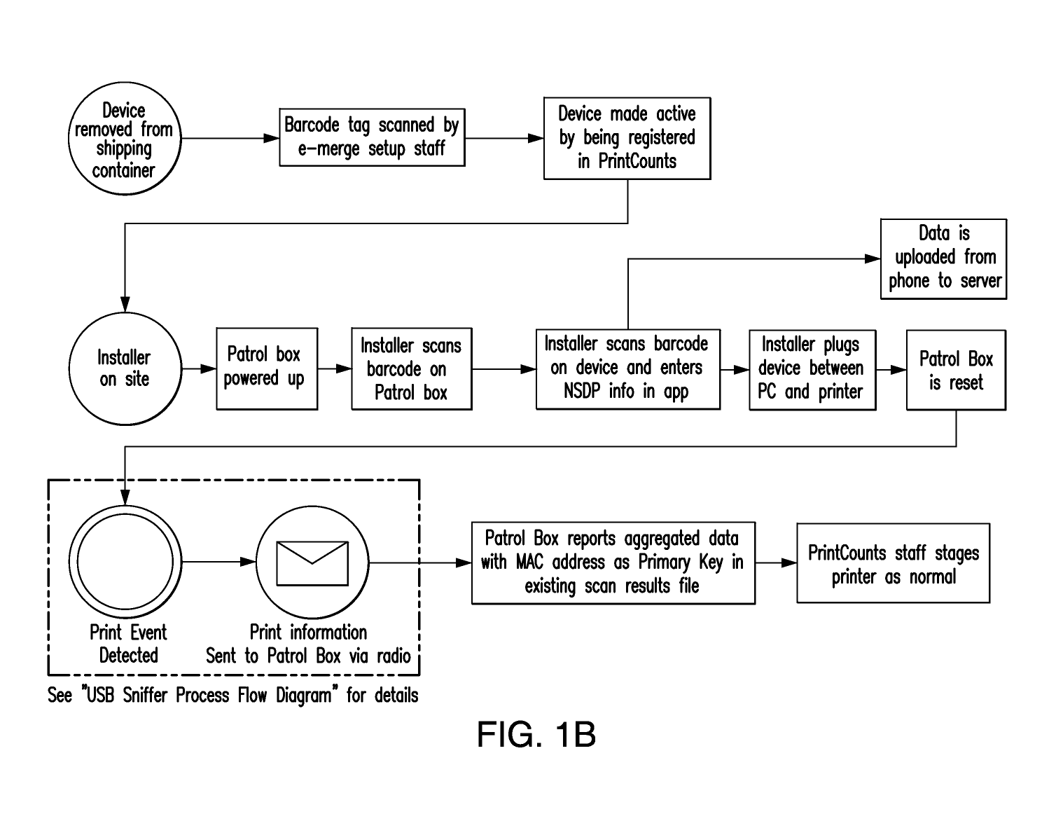

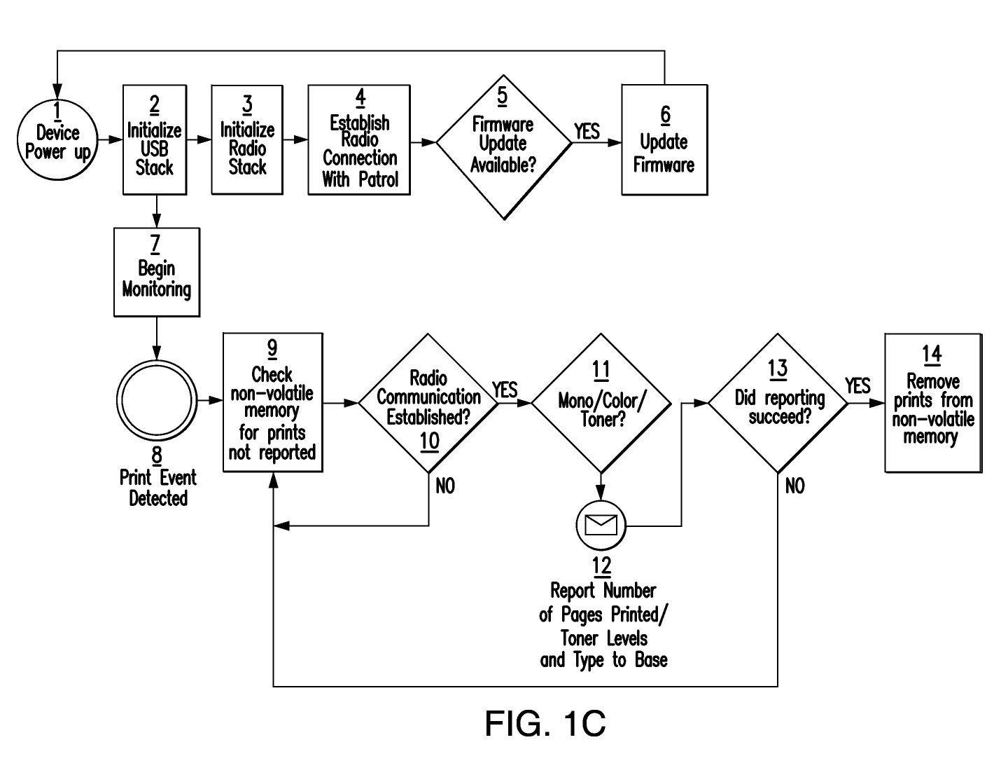

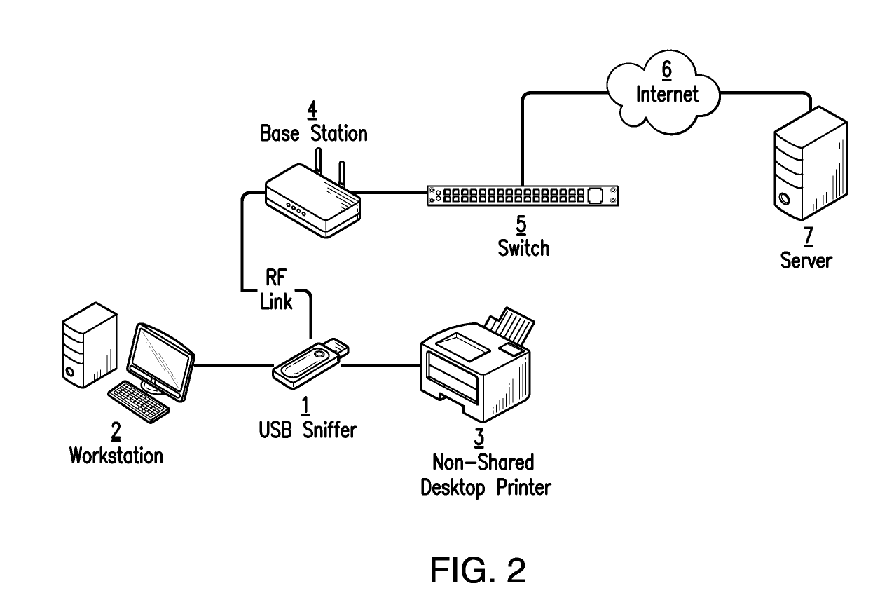

Initially with reference to FIG. 1A, an embodiment of the system and method of the present invention includes 1) removing a USB monitoring device from its original shipping container; 2) scanning a NFC tag on the USB device; 3) activating the USB device by registering it with a printer-related data reporting system; 4) powering up a base station; 5) scanning a NFC tag present on the base station; 6) scanning the NFC tag on the USB monitoring device and entering NSDP information into the system, whereby data relating to the device and base station are uploaded to the printer-related data reporting system's server; 7) connecting the USB monitoring device in-line between a computer and a printer; 8) resetting the base station; 9) initiating a print job and testing the functionality of the printer-related data monitoring system, wherein the system (see FIG. 2) includes passively monitoring the USB line by the USB device to detect printer actions and reporting data relating to printer actions to the base station via a mesh network, wherein the data is reported by the USB device to the base station via a radio frequency bandwidth, and wherein data relating to printer actions may include, but is not limited to, the number of pages printed, color, ink or toner density, and other printer-related data; 10) aggregating the printer-related data at the base station, wherein the base station subsequently reports the data via the internet to the printer-related data monitoring system staff; and 11) staging the printer as normal by printer-related data monitoring system staff.

With reference to FIG. 1B, another embodiment of the system and method of the present invention includes 1) removing a USB monitoring device from its original shipping container; 2) scanning a barcode tag on the USB device; 3) activating the USB device by registering it with a printer-related data reporting system; 4) powering up a base station; 5) scanning a barcode present on the base station; 6) scanning the barcode on the USB monitoring device and entering NSDP information into the system, whereby data relating to the device and base station are uploaded to the printer-related data reporting system's server; 7) connecting the USB monitoring device in-line between a computer and a printer; 8) resetting the base station; 9) initiating a print job and testing the functionality of the printer-related data monitoring system, wherein the system (see FIG. 2) includes passively monitoring the USB line by the USB device to detect printer actions and reporting data relating to printer actions to the base station via a mesh network, wherein the data is reported by the USB device to the base station via a radio frequency bandwidth, and wherein data relating to printer actions may include, but is not limited to, the number of pages printed, color, ink or toner density, and other printer-related data; 10) aggregating the printer-related data at the base station, wherein the base station subsequently reports the data via the internet to the printer-related data monitoring system staff; and 11) staging the printer as normal by printer-related data monitoring system staff.

In one embodiment of the system and method described herein, the scanning and activating steps are performed by a wireless or mobile device running custom application-specific software. The wireless or mobile device may be a NFC-compatible smartphone, the smartphone capable of communicating over a WiFi or cellular data network. In another embodiment, the wireless or mobile device may be a smartphone further comprising a camera, the smartphone capable of communicating over a WiFi or cellular data network.

In another embodiment of the invention, the scanning is performed by initiating the custom application-specific software and scanning the NFC tag with the smartphone, wherein the NSDP information is subsequently entered by a user or technician directly into the application-specific software and uploaded via WiFi or a cellular data network to a remote printer-related data monitoring system.

In yet another embodiment of the invention, the scanning is performed by initiating the custom application-specific software and capturing the barcode image with the smartphone camera, wherein the NSDP information subsequently entered by a user or technician directly into the application-specific software and uploaded via WiFi or a cellular data network to a remote printer-related data monitoring system.

In yet another embodiment of the present invention, the base station reports aggregated data with MAC address as Primary Key in existing scan results file. In another embodiment of the invention, the base station is a Patrol Box.

It will be understood by those of skill in the art that flowcharts and block diagrams herein described may illustrate architecture, algorithms, functionality, and operation of possible implementations of systems, methods and computer program products according to various embodiments. Therefore, it will be understood that each block in the flowchart or block diagram may represent a module, segment, or portion of code, which comprises one or more executable computer program instructions for implementing the specified logical function or functions. Further, some implementations may include the functions in the blocks occurring out of the order as herein presented. By way of non-limiting example, two blocks shown in succession may be executed substantially concurrently, or the blocks may at times be executed in the reverse order, depending upon the functionality involved. It will also be noted that each block of the block diagrams and flowcharts, and combinations of blocks in the block diagram and flowchart illustrations, may be implemented by special purpose hardware-based systems that perform the specified functions or acts, or combinations of special purpose hardware and computer program instructions.

The system includes one or more processing devices, which may be a computer processing unit, and could be a single central processing unit, or a number of processing units configured to operate either in sequence or in parallel. The processing device can be configured to execute software processes which implement the steps disclosed herein. The system may also include a memory capable of storing the steps necessary for a processing device to implement the steps disclosed herein. This memory could be in the form of memory resident within the processing device or in the form of standalone memory coupled to the processing unit via a communication path, such as a bus or a network.

Although this disclosure has been described in terms of certain embodiments and generally associated methods, alterations and permutations of these embodiments and methods will be apparent to those skilled in the art. Accordingly, the above description of example embodiments does not constrain this disclosure. Other changes, substitutions, and alterations are also possible without departing from the spirit and scope of this disclosure.

What is claimed is:

1. A system for pairing components of a printer-related data reporting system, the system comprising:
a first tag associated with a base station;
a second tag associated with a device operable for communicating printer-related data to the base station; and
a tag scanner operable for scanning the first and second tags,
wherein a scanning of the first and second tags results in an operable pairing of the base station and the device.

2. The system as described in claim 1, wherein the first and second tags comprise a near field communication tag.

3. The system as described in claim 2, wherein the tag scanner comprises a near field communication capable wireless device.

4. The system as described in claim 1, wherein at least one of the first and second tags comprise a barcode.

5. The system as described in claim 4, wherein the tag scanner comprises a wireless device operable for scanning the barcodes.

6. The system as described in claim 5, wherein the wireless device comprises a camera for scanning the barcode.

7. A method for pairing components of a printer-related data reporting system, the method comprising:
removing a printer-related data monitoring device from its shipping container;
scanning a tag associated with the monitoring device with a tag scanner; and
activating the monitoring device by registering it with a printer-related data reporting system,
wherein the system passively monitors printer-related data.

8. The method as described in claim 7, further comprising powering on a base station operable with the printer-related data reporting system.

9. The method as described in claim 8, further comprising scanning a tag associated with the base station with the tag scanner.

10. The method as described in claim 9, further comprising rescanning the tag associated with the monitoring device with the tag scanner.

11. The method as described in claim 10, further comprising entering NSDP information into the printer-related data reporting system, whereby data relating to the monitoring device and the base station are communicated to a server associated with the printer-related data reporting system.

12. The method as described in claim 11, wherein the entering NSDP information into the printer-related data reporting system includes entering the NSDP information into the tag scanner.

13. The method as described in claim 12, further comprising placing the monitoring device in communication with both a workstation and a printer.

14. The method as described in claim 13, further comprising initiating a print job to test the functionality of the printer-related data reporting system.

15. The method as described in claim 14, further comprising reporting data relating to the functionality of the printer-related data reporting system to the printer-related data reporting system.

16. The method as described in claim 15, further comprising staging the printer-related data reporting system as normal.

17. A method for pairing components of a printer-related data reporting system, the method comprising:
scanning a first tag on a USB monitoring device;
activating the USB monitoring device by registering it with the printer-related data reporting system;
powering up a base station;
scanning a second tag present on the base station;
scanning the first tag on the USB monitoring device and entering NSDP information into the system, whereby data relating to the device and base station are uploaded to the printer-related data reporting system's server;
connecting the USB monitoring device in-line between a computer and a printer;
resetting the base station;
initiating a print job and testing the functionality of the printer-related data monitoring system, wherein the system includes passively monitoring the USB line by the USB monitoring device to detect printer actions and reporting data relating to printer actions to the base station via a mesh network, wherein the data is reported by the USB monitoring device to the base station via a radio frequency bandwidth, and wherein data relating to printer actions includes at least one of a number of pages printed, color, ink density, toner density, and other printer-related data;
aggregating the printer-related data at the base station, wherein the base station subsequently reports the data via the internet to printer-related data monitoring system staff; and
staging the printer as normal by the printer-related data monitoring system staff.

18. The method as described in claim 17, wherein the scanning the first and second tags comprise scanning a near field communication tag.

19. The method as described in claim 17, wherein the scanning the first and second tags comprises scanning a barcode tag.

20. The method as described in claim 17, wherein the scanning and activating steps are performed by at least one of a wireless or a mobile device running custom application-specific software.
